(19) United States
(12) Patent Application Publication
(10) Pub. No.: US 2024/0026075 A1
(43) Pub. Date: Jan. 25, 2024

(54) POLYMERISATION PROCESSES

(71) Applicant: THE UNIVERSITY OF BATH, Bath (GB)

(72) Inventors: Antoine BUCHARD, Bath (GB); Thomas MCGUIRE, Bath (GB)

(21) Appl. No.: 18/041,361

(22) PCT Filed: Aug. 11, 2021
(86) PCT No.: PCT/GB2021/052082

§ 371 Date: Feb. 10, 2023

(30) Foreign Application Priority Data
Aug. 12, 2020 (GB) 2012564.7

(51) Int. Cl. C08G 65/18

(52) U.S. Cl. CPC C08G 65/18

(57) ABSTRACT

A polymerisation process is disclosed, the process having the steps of providing an oxetane derivative of a monosaccharide, providing an anionic initiator, forming a reaction mixture comprising the oxetane derivative of the monosaccharide and the anionic initiator, and initiating ring opening polymerisation reaction of the oxetane moiety of the oxetane derivative of the monosaccharide in the reaction mixture, thereby producing a polyether. The monosaccharide may be pentose or a hexose or a derivative of a pentose or hexose. The pentose may be xylose, in D or L form, or a mixture of D and L form. The hexose may be a derivative of galactose. Also disclosed are polyurethanes being a reaction product of an isocyanate and a polyether.

### FIELD

The present disclosure relates to polymerisation processes for producing polyethers, to polyethers produced by the processes, to polyether stereocomplexes to polyurethanes comprising reaction products of isocyanates and polyethers, and to co-polymers comprising the polyethers.

### BACKGROUND

Research on synthetic polysaccharides (i.e. ether linked poly carbohydrate derivatives) has been undertaken by Uryu et al. who reported on the cationic polymerisation of an array of anhydro-functionalised sugar-derivatives. Uryu et al. (Journal of Polymer Science: Polymer Letters Volume 17, Issue 10 (October 1979) Pages 673-678 “Cationic, ring-opening polymerization of 3,5-anhydro-1,2-O-isopropylidene-α-D-xylofuranose”; Die Makronmolekulare Chemie Volume 185, Issue 10 (October 1984) Pages 2099-2107) described a Lewis acid (e.g. BF₃·OEt₂ and PF₅) catalysed polymerisation of acetal protected D xylose in dichloromethane. The polymerisation proceeded under high vacuum to form a polymer of up to 15,800 g mol⁻¹ but with no demonstrable control over molecular weight. Propagation was determined to occur exclusively via a trialkyloxonium ion. Deprotection of the acetal group was achieved under acidic conditions although the deprotected polymer was characterised only by NMR.

Polyethers and especially polyether glycols have many interesting and useful properties. Polyethers are generally more stable than carbonyl containing analogues because of the reduced polarity about the polymer linkages. Consequently, they find applications in thermally active environments. Polyethers (with terminal and other hydroxyl groups) are feedstocks for polyurethanes and may provide polyurethanes with useful properties.

However, there have been problems in the past in providing polyethers with controlled chemical and physical properties and it would be advantageous to provide processes for producing polyethers that give more control of the chemical and physical properties of the resulting polyethers.

### SUMMARY

It is an aim of the present disclosure to address this issue.

In a first aspect there is accordingly provided a polymerisation process, the process comprising the steps of:
a. providing an oxetane derivative of a monosaccharide, optionally a pentose (furanose),
b. providing an anionic initiator,
c. forming a reaction mixture comprising the oxetane derivative of the monosaccharide and the anionic initiator, and
d. initiating ring opening polymerisation reaction of the oxetane moiety of the oxetane derivative of the monosaccharide in the reaction mixture, thereby producing a polyether.

The process of the present disclosure is particularly advantageous in that it provides greatly improved control over the polymerisation process allowing tuning of the chemical and physical properties of the product. In particular, the process of the present disclosure may provide improved control over the hydroxyl content, molecular weight and length of the polyether block.

Optionally the oxetane derivative of a monosaccharide is an oxetane derivative of a pentose, optionally an oxetane derivative of an aldopentose, and optionally an oxetane derivative of xylose.

The pentose may comprise an L-pentose, optionally L-xylose. Alternatively, or additionally (e.g. if there are two pentoses used in the process), the pentose may comprise an R-pentose, optionally R-xylose.

The monosaccharide may comprise a hexose derivative, optionally galactose or a galactose derivative, optionally galactal or a galactal derivative.

Advantageously, the process may be performed with little or no solvent, allowing greater control and more efficient use of the process. In some embodiments the reaction mixture may contain substantially no deliberately added solvent.

Thus, the reaction mixture may comprise 100 mol % to 50 mol %, optionally 100 mol % to 53 mol %, optionally 100 mol % to 58 mol % oxetane derivative of the monosaccharide (optionally the pentose).

A further advantage of the present disclosure is that it does not require vacuum conditions and may be performed for example at a pressure of 50 kPa or greater, optionally at substantially atmospheric pressure.

The reaction may be performed at a reaction temperature in the range 90° C. to 195° C., optionally 93° C. to 195° C., 96° C. to 195° C., 99° C. to 195° C., 103° C. to 195° C., 107° C. to 195° C., 113° C. to 195° C., 115° C. to 195° C., 117° C. to 195° C.

The process may further comprise performing the reaction for a reaction time in the range 1 hour to 24 hours.

Control of the process may be further improved by adjusting the ratio of initiator and starting material(s). Thus, the molar ratio of the oxetane derivative of the pentose to the anionic initiator may in the range 10:1 to 400:1, optionally 10:1 to 275:1, optionally 10:1 to 250:1.

In some embodiments, the anionic initiator may comprise triazabicyclodecene.

Examples of other initiators include metal alkoxides, metal hydroxide, amides, silanoates depending upon the cation and substituents selected. For example, the initiator may comprise aluminium tris isopropoxide or lanthanide alkoxide. Other possible initiators include precursors of metal alkoxides (e.g. organometallic compounds that may hydrolyse in situ due to residual moisture or sugar diol in the reaction mixture).

Thus, in some embodiments the anionic initiator may comprise a metal alkoxide and/or a metal amine, optionally a sodium or potassium alkoxide, optionally sodium or potassium butoxide.

If metal cations are present in the reaction mixture (e.g. from the counter ions of the anionic initiator) optionally the reaction mixture may further comprise a binding agent for metal cations to further improve control of the process. Examples of binding agents for metal cations comprise one or more crown ethers. Suitable crown ethers may be 18-crown-6 (e.g. for potassium cations), 15-crown-5 (e.g. for sodium cations), and 12-crown-4 (e.g. for lithium cations).

The oxetane derivative of the pentose is optionally synthesised from a protected pentose. Thus, the oxetane derivative of the pentose may be an oxetane derivative of a 1,2-O-isopropylidene protected pentose, optionally an oxetane derivative of 1,2-O-isopropylidene-xylofuranose.

In some embodiments, the oxetane derivative of a pentose may be provided by the steps of:
optionally, reacting the pentose in the presence of sulfuric acid and acetone to form an 1,2-O-isopropylidene protected pentose,
either iodination or tosylation of the primary hydroxyl of the pentose, and
cyclising the iodo- or tosyl-pentose, optionally by treatment with base (e.g. metal alkoxide such as KOMe) to form the oxetane derivative.

Suitably, the anionic initiator may have a linear or branched structure which is advantageous because it allows the polymer to be linear or branched. Control of the linear or branched structure of the polymer as produced by the process advantageously allows still further control over the properties of the product.

Polyethers obtainable by the process of the first aspect of the present disclosure have interesting and useful properties including those polyethers that may be formed of L pentoses and/or a mixture of L and R pentoses.

The oxetane derivative of a hexose may comprise a compound of formula

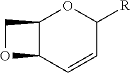

wherein R is selected from H, OR′, C₁₋₈ alkyl, C₃₋₇ alkenyl, C₂₋₇ alkynyl, C₅₋₂₀ aryl, C₃₋₁₀ cycloalkyl, C₃₋₁₀ cycloalkenyl, C₃₋₁₀ cycloalkynyl, C₃₋₂₀ heterocyclyl, C₃₋₂₀ heteroaryl; R′ is selected from H, C₁₋₈ alkyl, C₃_₇ alkenyl, C₂₋₇ alkynyl, C₅₋₂₀ aryl, C₃₋₁₀ cycloalkyl, C₃₋₁₀ cycloalkenyl, C₃₋₁₀ cycloalkynyl, C₃₋₂₀ heterocyclyl, C₃₋₂₀ heteroaryl.

In a second aspect, the present disclosure provides a polyether (suitably a linear or branched polyether) of formula:

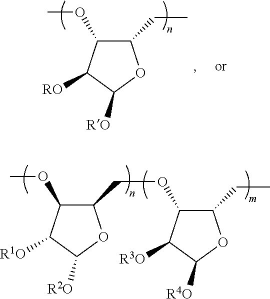

wherein n and m are independently 3 to 3500, and
R, R′, R¹, R², R³ and R⁴ are independently selected from H, PR⁵R⁶, P(O)R⁵R⁶, P(S)R⁵R⁶, BR⁵R⁶, Si(R⁵)₃, Si(OR⁵)₃, C₁₋₈ alkyl, C₃₋₇ alkenyl, C₂₋₇ alkynyl, C₅₋₂₀ aryl, C₃₋₁₀ cycloalkyl, C₃₋₁₀ cycloalkenyl, C₃₋₁₀ cycloalkynyl, C₃₋₂₀ heterocyclyl, and C₃-2 heteroaryl, or R and R′, or R¹ and R², or R³ and R⁴ together with the oxygens to which they are bonded form an isopropylidene acetal (ketal), or R and R′, or R¹ and R², or R³ and R⁴ are bonded to a divalent group, and
each R⁵ and R⁶ are independently selected from H, C₁₋₈ alkyl, C₅₋₂₀ aryl, C₃₋₁₀ cycloalkyl, C₃₋₂₀ heterocyclyl, and C₃₋₂₀ heteroaryl.

R and R′, or R¹ and R², or R³ and R⁴ may be bonded to a divalent group selected from —OP(R⁷)O— or —OB(R⁷)O— so that the polyether may be of formula:

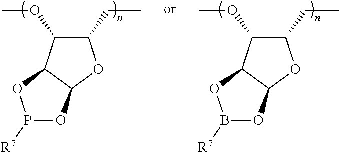

wherein each R⁷ is independently selected from H, C₁₋₈ alkyl, C₅₋₂₀ aryl, C₃₋₁₀ cycloalkyl, C₃₋₂₀ heterocyclyl, and C₃₋₂₀ heteroaryl, and each n is 3 to 3500.

In a third aspect, the present disclosure provides a polyether stereocomplex (suitably a linear or branched polyether stereocomplex) comprising polyethers of formula

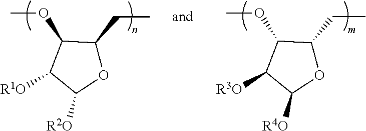

wherein n and m are independently 3 to 3500, and
R¹, R², R³ and R⁴ are independently selected from H, C₁₋₈ alkyl, C₃₋₇ alkenyl, C₂₋₇ alkynyl, C₅₋₂₀ aryl, C₃₋₁₀ cycloalkyl, C₃₋₁₀ cycloalkenyl, C₃₋₁₀ cycloalkynyl, C₃₋₂₀ heterocyclyl, C₃₋₂₀ heteroaryl, or R and R′, or R¹ and R², or R³ and R⁴ together with the oxygens to which they are bonded form an isopropylidene acetal (ketal) or R¹ and R², or R³ and R⁴ are bonded to a divalent group.

Polyethers of the present disclosure (which may have varying amounts/numbers of hydroxyl groups depending on the control of process conditions) have many uses.

Thus, in a fourth aspect, there is provided a polyurethane comprising a reaction product of an isocyanate and a polyether according to the second aspect, and/or a polyether stereocomplex according to the third aspect.

In a fifth aspect, the present disclosure provides a polyurethane according to the fourth aspect and its use as an adhesive, or as a coating.

In a sixth aspect the present disclosure provides a compound of formula

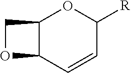

wherein R is selected from H, OR′, C₁₋₈ alkyl, C₃₋₇ alkenyl, C₂₋₇ alkynyl, C₅₋₂₀ aryl, C₃₋₁₀ cycloalkyl, C₃₋₁₀ cycloalkenyl, C₃₋₁₀ cycloalkynyl, C₃₋₂₀ heterocyclyl, C₃₋₂₀ heteroaryl; R′ is selected from H, C₁_₈ alkyl, C₃_₇ alkenyl, C₂₋₇ alkynyl, C₅₋₂₀ aryl, C₃₋₁₀ cycloalkyl, C₃₋₁₀ cycloalkenyl, C₃₋₁₀ cycloalkynyl, C₃₋₂₀ heterocyclyl, C₃₋₂₀ heteroaryl. The compound may be galactal oxetane ((1R,6R)-2,7-dioxabicyclo[4.2.0]oct-4-ene).

Further particular and preferred aspects are set out in the accompanying independent and dependent claims. Features of the dependent claims may be combined with features of the independent claims as appropriate, and in combinations other than those explicitly set out in the claims, as supported by the description.

### BRIEF DESCRIPTION OF THE DRAWINGS

Embodiments of the present disclosure will now be described further, with reference to the accompanying drawings, in which:

FIG. 1 ¹H NMR spectra (400 MHz, CDCl₃, 1.00-6.60 ppm) of a) D-Ox, b) poly(D-Ox) or poly (L-Ox) and c) poly(D-Ox/L-Ox).

FIG. 2 Time vs conversion of D-Ox for a polymerisation performed at 150° C. with [D-Ox]:[KOtBu] loading of 20:1.

FIG. 3 Initial rate plot of the polymerisation of D-Ox carried out at 150° C. with [D-Ox]:[KOtBu] loading of 20:1 (k_{obs}=0.0248 min⁻¹).

FIG. 4 Conversion of D-Ox vs M_{n,SEC} vs ÐM for a polymerisation carried out at 150° C. with [D-Ox]: [KOtBu] loading of 20:1.

FIG. 5 ¹H NMR spectrum (400 MHz, CDCl₃, 1.20-6.20 ppm) of block-poly (D-Ox/L-Ox).

FIG. 6 ¹H homonuclear decoupled NMR spectrum of (a) poly (D-Ox) (M_{n,sec}=9100, Ð_{M}=1.16), (b) 50:50 poly (D-1/L-1) (M_{n,sec}=9300, Ð_{M}=1.17) and (c) block poly (D-Ox/L-Ox) (M_{n,sec}=5300, Ð_{M}=1.50) irradiated at 6=4.62 ppm.

FIG. 7 Derivative of mass loss by TGA (300-420° C.) for poly (D-Ox) (black, M_{n,SEC}=8300 g mol⁻¹, ÐM=1.30), Poly (L-Ox) (red, M_{n,SEC}=9500 g mol⁻¹, ÐM=1.18) and poly (D-Ox/L-Ox) (orange, M_{n,SEC}=15000 g mol⁻¹, ÐM=1.11).

FIG. 8(a) DSC thermogram (−40-300° C.) measured at a scan rate of 20° C. min⁻¹ showing the 1st cooling and 2nd heating cycle of poly (L-Ox) (M_{n,SEC}=9500 g mol⁻¹, ÐM=1.18) and (b) poly (D-Ox/L-Ox) (M_{n,SEC}=15000 g mol⁻¹, ÐM=1.11).

FIG. 9(a) DSC trace collected at 20° C. min⁻¹ showing the first cooling and second heating cycle under argon of poly(D-Ox) precipitated from Et₂O (M_{n,SEC}=9100 g mol⁻¹, Ð_{M}=1.16; T_{g}=135° C.; Tₘ=248° C.; T_{c}=248° C.); (b) DSC trace collected at 20° C. min⁻¹ showing the first and second heating cycle under argon of 90:10 poly(D-Ox/L-Ox) precipitated from hexane (M_{n,SEC}=7900 g mol⁻¹, Ð_{M}=1.20; T_{g} (second heating cycle)=124° C.; Tₘ (second heating cycle)=not observed; T_{c} (first cooling)=not observed); (c) DSC trace collected at 20° C. min⁻¹ showing the first cooling and second heating cycle under argon of 90:10 poly(D-Ox/L-Ox) precipitated from hexane (M_{n,SEC}=7900 g mol⁻¹, Ð_{M}=1.20; T_{g}=124° C.; Tₘ=not observed; T_{c}=not observed); (d) DSC trace collected at 20° C. min⁻¹ showing the first cooling and second heating cycle under argon of 70:30 poly(D-Ox/L-Ox) precipitated from hexane (M_{n,SEC}=10100 g mol⁻¹, Ð_{M}=1.18; T_{g}=125° C.; Tₘ=not observed; T_{c}=not observed).

FIG. 10 WAX profiles of poly (D-Ox) (black, M_{n,SEC}=8300 g mol⁻¹, ÐM=1.30), Poly (L-Ox) (red, M_{n,SEC}=9500 g mol⁻¹, ÐM=1.18) and poly (D-Ox/L-Ox) (orange, M_{n,SEC}=15000 g mol⁻¹, ÐM=1.11).

FIG. 11 WAX profiles of poly (D-Ox) (black M_{n,SEC}=8300 g mol⁻¹, ÐM=1.30) and 63% deprotected poly (D-Ox) (green).

FIG. 12(a) DSC trace collected at 20° C. min⁻¹ showing the first cooling and second heating cycle under argon of a 50:50 blend of poly(D-Ox) and poly(L-Ox) formed by evaporation of HCCl₃ (T_{g}=136° C.; Tₘ=288° C.; T_{c}=224° C.);
(b) DSC trace collected at 20° C. min⁻¹ showing the first cooling and second heating cycle under argon of a 75:25 blend of poly(D-Ox) and poly(L-Ox) formed by evaporation of HCCl₃ (T_{g}=130° C.; Tₘ₁=264° C., Tₘ₂=274° C., Tₘ₃=284° C.; T_{c}=219° C.).

FIG. 13 WAX profiles of poly (L-Ox) (red, M_{n,SEC}=9400 g mol⁻¹, ÐM=1.29), poly (D-Ox) (black, M_{n,SEC}=9100 g mol⁻¹, ÐM=1.25) and 50:50 (blue) and 75:25 (green) blends of poly (L-Ox) and poly (D-Ox).

FIG. 14 shows 1H NMR of galactal derived oxetane in CDCl₃.

FIG. 15 shows a graph of time vs oxetane conversion (determined by 1H NMR (d⁶-DMSO) spectroscopy by relative integration of the anomeric protons in oxetane (6=6.27 ppm (d, J=3.7 Hz)) and poly(branched oxetane) (6=5.90-5.50 ppm (m)) for the KOH initiated ROP of oxetane at [oxetane]₀:[KOH]₀:[pentaerythritol]₀ loadings of 4:4:1 at 150° C.

FIG. 16 shows the 1H NMR spectrum (CDCl₃) of poly(branched oxetane).

FIG. 17 shows the FTIR spectrum of poly(branched oxetane).

FIG. 18 shows ³¹P{¹H} NMR spectrum (CDCl₃) following the reaction of poly(branched oxetane) with 2-chloro-4,4,5,5-tetramethyl dioxaphospholane with bisphenol A used as an internal standard.

FIG. 19 shows (a) the SEC chromatogram of poly(branched oxetane) (M_{n,SEC}=4200 g mol-1, Ð_{M}=1.68) measured in DMF; and (b) SEC chromatogram of product of the reaction between poly(branched oxetane) and methylene diphenyl diisocyanate (M_{n,SEC}=4200 g mol⁻¹, Ð_{M}=3.09) measured in DMF.

### DETAILED DESCRIPTION

### Overview

The present disclosure deals with embodiments of polyethers produced from oxetane derivatives of xylose and galactal.

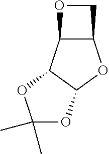

3,5-anhydro-1,2-O-isopropylidene-α-D-xylofuranose (D-Ox)

The starting point for the formation of the oxetane derivative was acetal protected xylose:

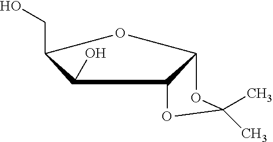

### 1,2-O-Isopropylidene-α-D-xylofuranose

The present disclosure relates to work on the development of a highly-regioselective, anionic homopolymerisation of D-Ox to give control over molecular weight under a simple reaction setup (Scheme 1) and to stereocomplexes formed from D Ox and the L form, L Ox.

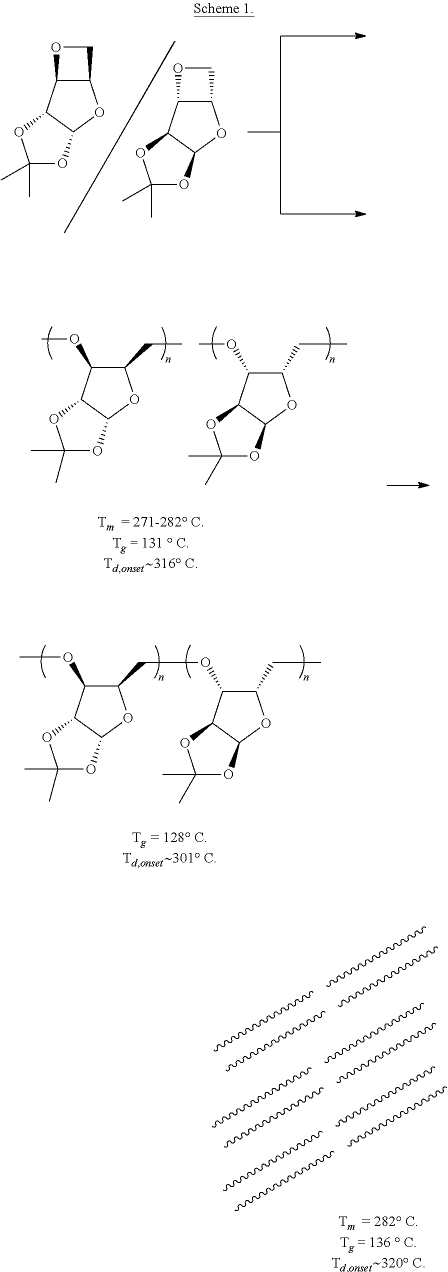

Poly (D-Ox) was found to be thermally robust (T_{d},onset˜316° C.) and highly crystalline (Tₘ˜271° C., T_{g}=128° C.). The impacts of deprotection were studied, with the occurrence of reversible cross-linking detected by GPC. Finally, the effects of tacticity were investigated through L-Ox polymerisations. This includes the synthesis of amorphous atactic poly (D/L-Ox) (T_{g} 128° C.), and study of the effects of blends of poly (D-Ox) and poly (L-Ox); resulting in the formation of a stereocomplex (Tₘ=288° C.).

Following protection of the a,b positions, syntheses of D-Ox may involve transformation of the primary hydroxyl into a leaving group (e.g. halide or tosylate) followed by cyclisation incurred through Brønsted base activation of the secondary hydroxyl. Protection of the a,b positions was performed in accordance with Scheme 2. Reaction of D-xylose in the presence of H₂SO₄ and acetone forms the di-protected derivative which, following partial neutralisation, undergoes graded hydrolysis to the a,b-protected substrate, 1,2-O-isopropylidene-D-xylofuranose (IPXF). Isolation through aqueous extraction followed by successive washes with DCM, yields IPXF in 97% yield.

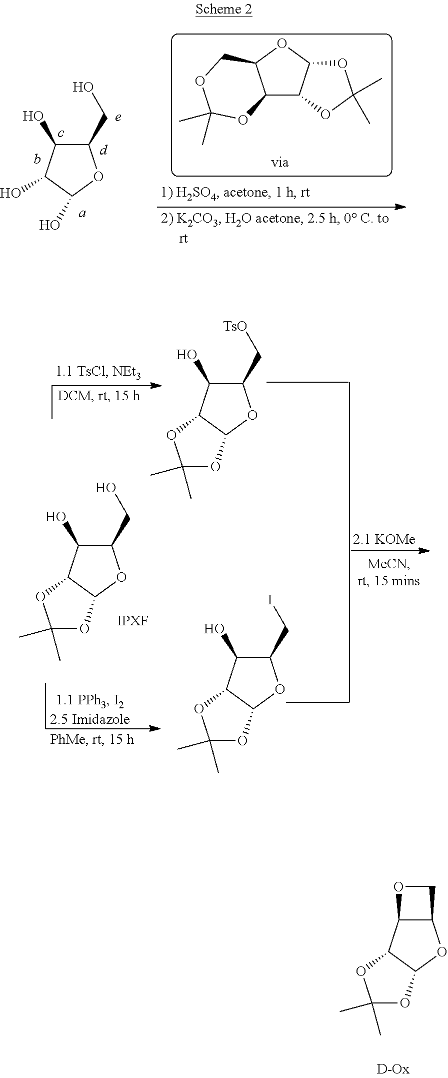

Two routes were explored for the cyclisation. Firstly, iodination via an Appel reaction of the primary hydroxyl, formed iodo adduct X, in 86% yield following isolation by column chromatography. Alternatively, tosylation of the primary hydroxyl gives tosyl ester Y in 74% yield without use of a column, thereby improving scalability. Cyclisation of either adduct proceeds quantitatively in the presence of excess KOMe. An aqueous workup followed by distillation over CaH₂ gives D-Ox of suitable purity for polymerisation, in 73% yield. An otherwise identical procedure starting from L-xylose yields L-Ox in 74% yield. It is also possible to the synthesise the oxetane in one pot using either leaving group strategy however isolation requires a column so is less practical for scale up.

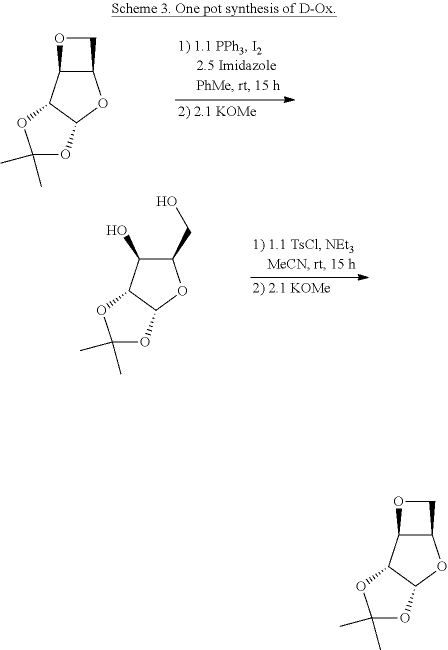

### 1 Homopolymerisation (Pentose Derivatives)

### 1.1 Initiator and Catalyst Screening

The homopolymerisation of D-Ox was investigated. In view of sustainability, a solvent-free polymerisation was first examined. Anionic initiators were investigated, namely, KOtBu, KOEt, NaOMe, NaOtBu, TBD and SnOct2). These anionic initiators have proven to improve control over the polymerisation (as compared with cationic initiators) and simplify experimental setup (e.g. avoid the use of in-situ high vacuum). Results are presented in Table 1. No activity for the polymerisation was observed at room temperature with KOtBu at [D-Ox]0:[KOtBu]0 loadings of 20:1 after 17 h (Table 1 entry 1). Increasing the temperature to 120° C. resulted in 18% conversion after 3 h, while a reaction performed at 150° C. gave 97% conversion (Table 1, entries 2 and 3, respectively). Subsequent experiments, with varied KOtBu loadings, showed that molecular weights, as determined by M_{n,SEC}, were in reasonable agreement with M_{n,theo} (Table 1, entries 3-7) and indicated good control (Ð_{M}=1.29-30).

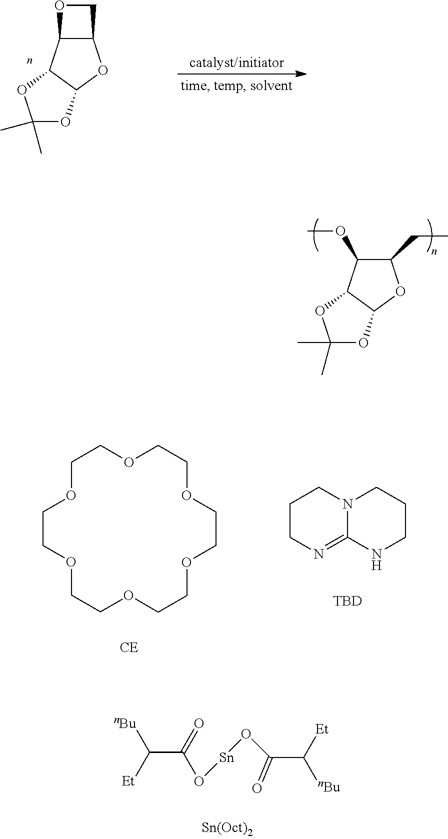

TABLE 1
Anionic polymerisation of D-Ox and L-Ox.

| | | Initiator/ | Temp | Time | Conv | Mn, theo | Mn, SEC | |
|---|---|---|---|---|---|---|---|---|
| Example | [Ox]ₒ:[I]ₒ | Catalyst | (° C.) | (h) | (%)[a] | (g mol⁻¹) | (ÐM)[b] | |
| 1[c] | 20:1 | KO^{t}Bu | 22 | 17 | 0 | — | — | |
| 2[c] | 20:1 | KO^{t}Bu | 120 | 3 | 28 | 1200[d] | — | |
| 3[c] | 20:1 | KO^{t}Bu | 150 | 3 | 97 | 3600[d] | 4300 | (1.30) |
| 6 | 50:1 | KO^{t}Bu | 150 | 17 | 69 | 6200[d] | 6600 | (1.29) |
| 7 | 100:1 | KO^{t}Bu | 150 | 17 | 63 | 11100[d] | 8300 | (1.30) |
| 8[e] | 100:1 | KO^{t}Bu | 120 | 17 | 77 | 13400[d] | 9200 | (1.15) |
| 9[e] | 200:1 | KO^{t}Bu | 120 | 22 | 47 | 16300[d] | 14500 | (1.18) |
| 10[e] | 400:1 | KO^{t}Bu | 120 | 22 | 5 | 3500[d] | 8000 | (1.15) |
| 11[e], [f] | 100:1 | KO^{t}Bu | 120 | 70 | 4 | — | — | |
| 12[g] | 200:1 | Sn(Oct)2 | 120 | 22 | 1 | — | — | |
| 13[g] | 200:1 | Sn(Oct)2 | 180 | 22 | 1 | — | — | |
| 14[g] | 100:1 | TBD | 120 | 22 | 1 | — | | |
| 15[g] | 100:1 | TBD | 180 | 22 | 18 | 3200[h] | <1000 | |
| 16[c] | 20:1 | KOEt | 120 | 3 | 60 | 2100[i] | 4000 | (1.20) |
| 17 | 20:1 | NaOMe | 150 | 20 | 0 | — | — | |
| 18 | 20:1 | NaO^{t}Bu | 150 | 20 | 0[j] | — | — | |
| 19[k] | 100:1 | NaO^{t}Bu | 120 | 17 | 28 | 4900[d] | 7300 | (1.24) |
| 20[e], [l] | 100:1 | KO^{t}Bu | 120 | 22 | 51 | 8900[d] | 9800 | (1.19) |
| 21[e], [m] | 100:1 | KO^{t}Bu | 120 | 22 | 43 | 7500 [d] | 7900 | (1.20) |
| 22[e], [n] | 100:1 | KO^{t}Bu | 120 | 22 | 54 | 9400[d] | 10100 | (1.18) |
| 23[e], [o] | 100:1 | KO^{t}Bu | 120 | 22 | 61 | 10600 [d] | 9700 | (1.18) |

Reactions carried out in neat D-Ox with initiators dosed as stock solutions unless otherwise stated. ^{[a]} Calculated by the relative integration of the anomeric protons in D-Ox (6=6.27 ppm (d, J=3.7 Hz)) and poly(D-Ox) (6=5.88 ppm (d, J=3.5 Hz)). ^{[b]} Calculated by SEC relative to a polystyrene standard using a THF eluent; ÐM=M_{w}/Mₙ as determined by SEC. ^{[c]} Initiator dosed as solid. ^{[d]} Calculated as Mr(^{t}BuOH)+(Mr(D-Ox)×[D-Ox]0/[KO^{t}Bu]0×conv/100%). ^{[e]} Reaction carried out in presence of 18-crown-6; [KO^{t}Bu]0:[18-crown-6]0=1:1. ^{[f]}[D-Ox]0=4.0 mol L⁻¹ in σ-Cl2Ph. ^{[g]} Reaction carried out in presence of 4-MeBnOH, [D-Ox]0:[4-MeBnOH]0=100:1. ^{[h]} Calculated as Mr(4-MeBnOH)+(Mr (D-Ox)×[D-Ox]0/[4-MeBnOH]0×conv/100%). ^{[i]} Mr(EtOH)+(Mr(D-Ox)×[D-Ox]0/[KOEt]0×conv/100%). ^{[j]} HCCl₃—, THF- and DMSO-insoluble solid residue formed ^{[k]} Reaction carried out in presence of 15-crown-5; [KO^{t}Bu]0:[15-crown-5]0=1:1. ^{[l]} Reaction carried out with L-Ox. ^{[m]} Reaction carried out with [D-Ox]0:[L-Ox]0=9:1. ^{[n]} Reaction carried out with [D-Ox]0:[L-Ox]0=7:3. ^{[o]} Reaction carried out with [D-Ox]0:[L-Ox]0=1:1.

If the reaction is conducted on a small scale, conveniently (especially for higher loadings e.g. 10:1 or 20:1), KOtBu may be added as a solid. For lower loadings (e.g. 50:1, 100:1, 200:1), KOtBu may be added as a 0.5 M solution in THF. The solvent may be evaporated over stirring under Argon.

Polymerisations were conducted in the presence of 18-crown-6. Without wishing to be bound, 18-crown-6 may abstract K⁺ from the growing polymer chain thereby exposing the propagating alkoxide to enhance activity. At 120° C. with [KOtBu]0: [18-crown-6]0 loadings of 1:1, improved conversions were observed with a concurrent narrowing of ÐM (1.11-1.19, Table 1, entries 8-10). Variation of the KOtBu loading gave good molecular weight control with M_{n,SEC} values of up to 14500 g mol⁻¹ (ÐM=1.18) obtained after 22 h with a [D-Ox]0:[KOtBu]0:[18-crown-6]0 feed ratio of 200:1:1 (Table 1, entry 9). Further reduction in the KOtBu loading to 400:1 resulted in poor conversion of D-Ox, possibly as a result of residual monomer impurities leading to chain termination (Table 1, entry 10). Generally, non-quantitative conversions (<77%) were obtained, consistent with the low strain of the monomer. Moreover, the rate of the reaction is progressively slowed due to solidification of the reaction mixture prior to completion, which may limit conversions. A reaction performed at [D-Ox]₀=4.0 mol L⁻¹ in ortho-dichlorobenzene however, gave only 4% conversion of D-Ox after 70 h, Table 1, entry 11), again in agreement with the low favourability of the polymerisation due to low monomer strain. Reactions performed with Sn(Oct)2 and TBD in the presence of 4-MeBnOH both failed to induce propagation at 120° C., with only 1% conversion obtained (Table 1, entries 12 and 14, respectively). Increasing the reaction temperature to 180° C. also failed to yield polymer, with minimal conversion observed with Sn(Oct)2, while TBD gave 18% conversion with the isolated product being oligomeric (M_{n,sec}<1000 g mol⁻¹, Table 1, entries 13 and 15 respectively).

Next, NaOMe and NaOtBu were investigated as initiators. A polymerisation performed at 150° C. with [D-Ox]₀:[NaOMe]₀ loadings of 20:1 failed to give any D-Ox conversion (Table 1, entry 17). Under analogous conditions using NaOtBu, a THF, HCCl₃ and DMSO-insoluble residue was formed suggesting polymerisation had occurred but with significant cross-linking of the polyether chains (Table 1, entry 18). Finally, a polymerisation performed in the presence of 15-crown-5 at a [D-Ox]₀:[NaO^{t}Bu]₀:[15-crown-5]₀ feed ratio of 100:1:1 gave 28% conversion of D-Ox after 17 h to yield poly (D-Ox) of 7300 g mol⁻¹ with narrow dispersity ÐM (1.24) (Table 1, entry 18).

### 1.2 Polymerisation of L-Ox and Co-Polymerisation

The polymerisation of L-Ox was investigated. The polymerisation proceeded well at [L-Ox]:[KOtBu]:[CE] loadings of 100:1:1 to yield polymer of comparable molecular weight (M_{n,SEC}=9800 g mol⁻¹) and ÐM (1.19) to that obtained with D-Ox (Table 1, entry 19).

Random copolymerisations were also carried out at 120° C. with [D-Ox]₀:[L-Ox]₀:[KO^{t}Bu]₀:[18-crown-6]₀ loadings of 90:10:1:1, 70:30:1:1 and 50:50:1:1 (Table 1, entries 20-23). The reactions proceeded as expected in each case, albeit without solidification of the reaction mixtures, suggesting significant alteration of the physical properties of the copolymers.

### 1.3 NMR Characterisation of Polyethers

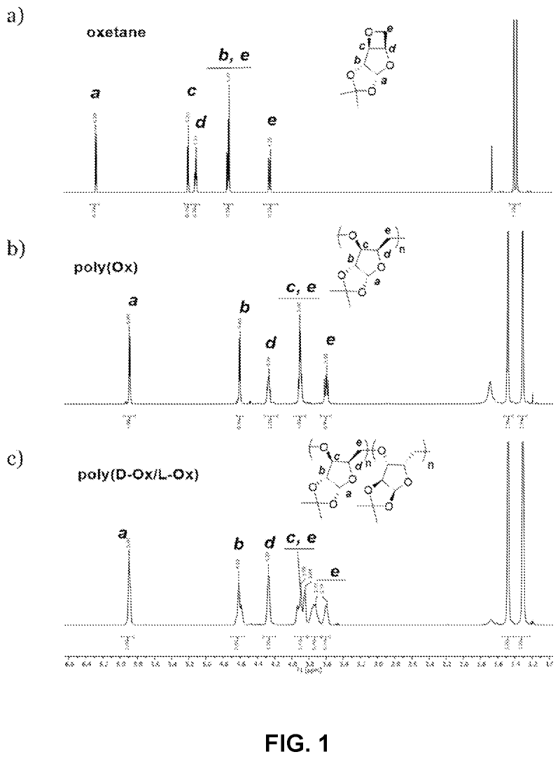

1H and 1H {13C} NMR spectroscopy indicated that polymerisation of Ox using KOtBu and 18-crown-6 and NaOtBu/15-crown-5 is ring-selective and highly regioregular (FIG. 1).

Through comparison of the 1H spectra of Ox and poly(Ox), the most significant ppm shift of protons corresponds to environments e-c, indicating a substantial conformational change across the oxetane moiety (Δppm c=1.35, Δppm d=0.83 and Δppm e=0.85 and 0.65 ppm) and suggestive of exclusive opening across the ring.

Due to the asymmetry of the oxetane, cleavage may form either a primary or secondary alkoxide, which, upon propagation, may incur head-to-tail (HT), tail-to-tail (TT) or head-head (HH) linkages. 1H {13C} NMR spectroscopy reveals the presence of only one major resonance per environment, which is inconsistent with TT or HH configurations, as the presence of either linkage would necessitate the occurrence of the other.

### 1.4 Kinetics of Polymerisation

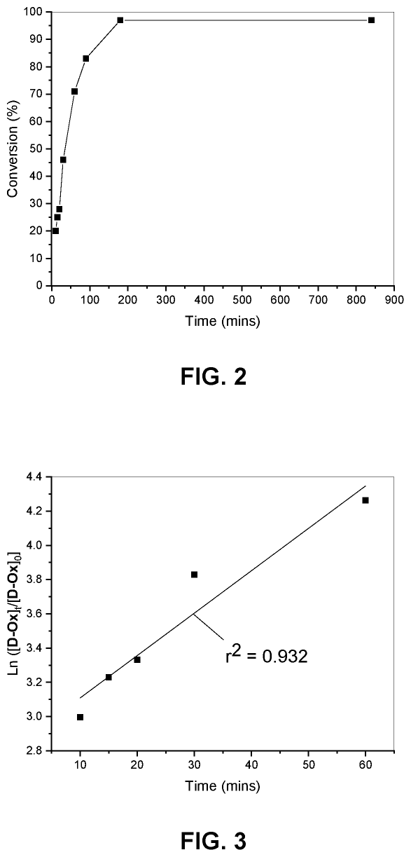

Kinetic experiments were conducted in parallel with KOtBu at [KOtBu]0:[D-Ox]0 loadings of 20:1 at 150° C. The polymerisation proceeded rapidly with 97% conversion after 3 h (FIG. 2).

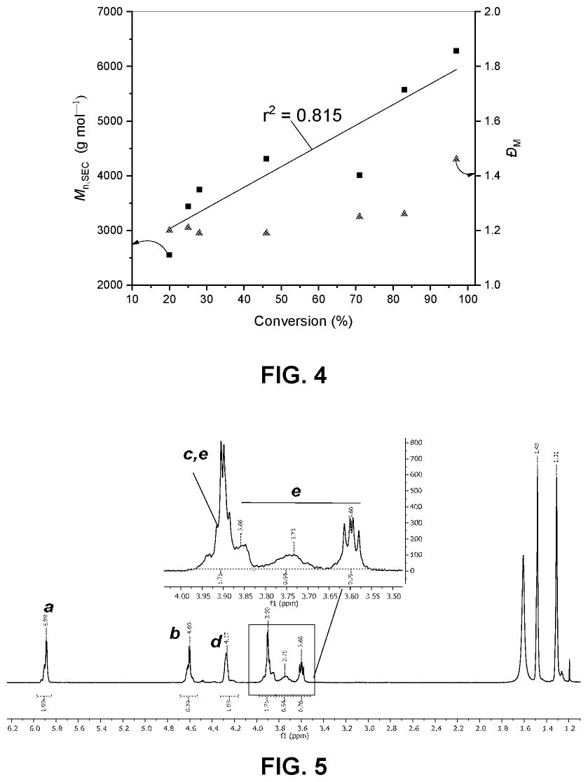

Initial rate plots show the polymerisation is pseudo first order in monomer concentration (FIG. 3, kobs=0.0248 min⁻¹). Slight deviation from a fully linear relationship between conversion and M_{n,SEC} was observed and values obtained were generally higher than M_{n,theo}(FIG. 4). Good polymerisation control was exhibited up to 3 h (ÐM=1.19-1.26) after which broadening was observed (ÐM=1.46).

### 1.5 Stereoblock Synthesis

A polymerisation at [D-Ox]:[KOtBu] loadings of 20:1 at 150° C. (Scheme 4) was performed. Following addition of L-Ox after 6 h (20:1 ratio relative to [KOtBu]0), 61% conversion was obtained indicating at least 11% of the L-Ox had been incorporated into the polymer. SEC analysis revealed a broad ÐM (1.50) and the presence of a low Mn shoulder suggestive of a degree of homopolymerisation of L-Ox. 1H DOSY NMR spectroscopy confirmed incorporation of both oxetane enantiomers within the same polymer chains.

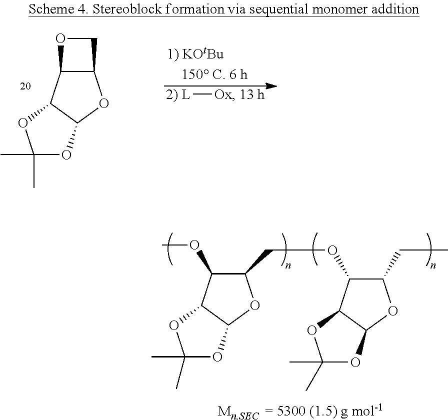

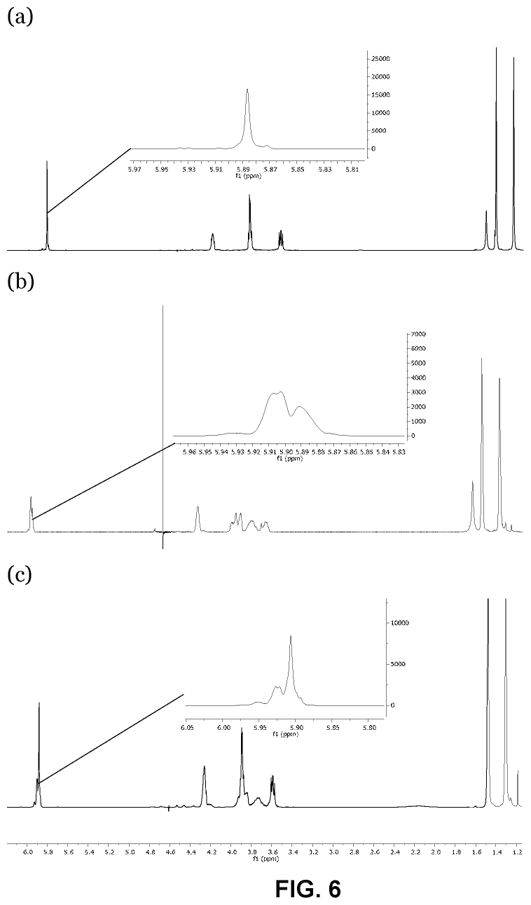

Qualitative analysis of the 1H NMR spectrum of block poly(D-Ox/L-Ox) reveals broadening of resonances as compared with the homopolymers, although to a lesser extent than for poly (D-Ox/L-Ox) (FIGS. 5, 6 and 1). In addition, deviation from the 1:2:1 integration ratio of the e environments observed with poly (D-Ox/L-Ox), rather than observation of only two e resonances, may be indicative of a stereogradient, rather than stereoblock, structure. Inspection of ¹H {¹H} NMR spectra of block poly(D-Ox/L-Ox) supports this conclusion: irradiation of resonances associated with the b positions reveals multiple anomeric environments consistent with a stereogradient structure.

### 1.6 Thermal Properties

The thermal properties of homo and copolymers were investigated by thermogravimetric analysis (TGA) and differential scanning calorimetry (DSC).

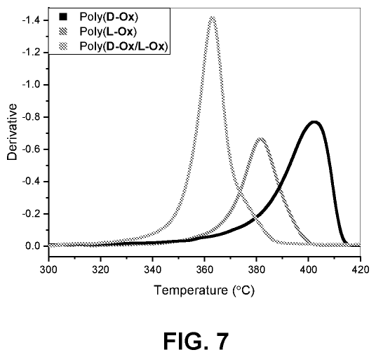

TGA indicated that all polyethers had a T_{d},onset above 300° C., with each exhibiting only a single degradation regime (FIG. 7). Poly(D-Ox/L-Ox) (M_{n,SEC}=15000 g mol⁻¹, ÐM=1.11) was found to be less thermally stable than both poly(D-Ox) (M_{n,SEC}=8300 g mol⁻¹, ÐM=1.30) and poly(L-Ox) (M_{n,SEC}=9500 g mol⁻¹, ÐM=1.18). with a lower T_{d,onset} (301° C., 315° C. and 318° C., respectively) and T_{d5} (342° C., 348° C. and 355° C., respectively). A variation in the T_{d,max} between the polymers was also observed, with poly(D-Ox) exhibiting the highest T_{d,max} (402° C.) as compared with poly(L-Ox) (382° C.). and poly (D-Ox/L-Ox) (363° C.). The percentage of char remaining at 600° C. varied from 20% for poly(D-Ox/L-Ox) to 14% for poly(D-Ox) and 13% for poly (L-Ox). The high thermal stability of the polyethers contrasts with similar carbonate-linked, mannose derived polymer, which degrades around 170° C., and highlights the impact of linker modification with regards to polymer properties

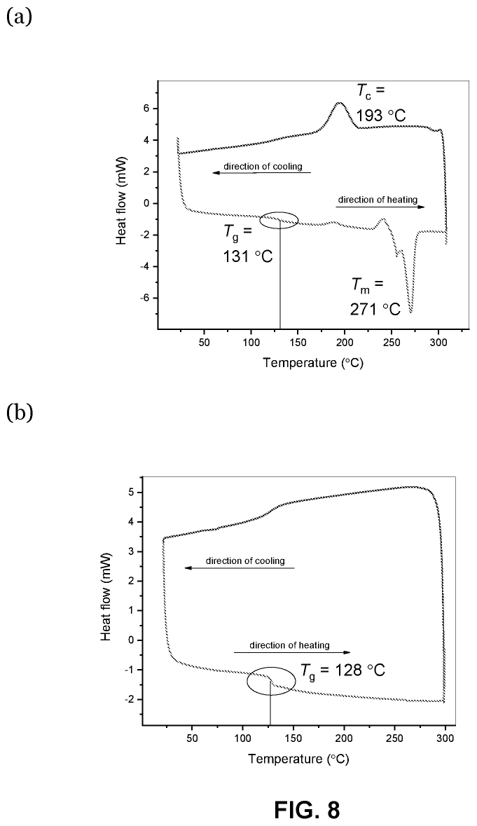

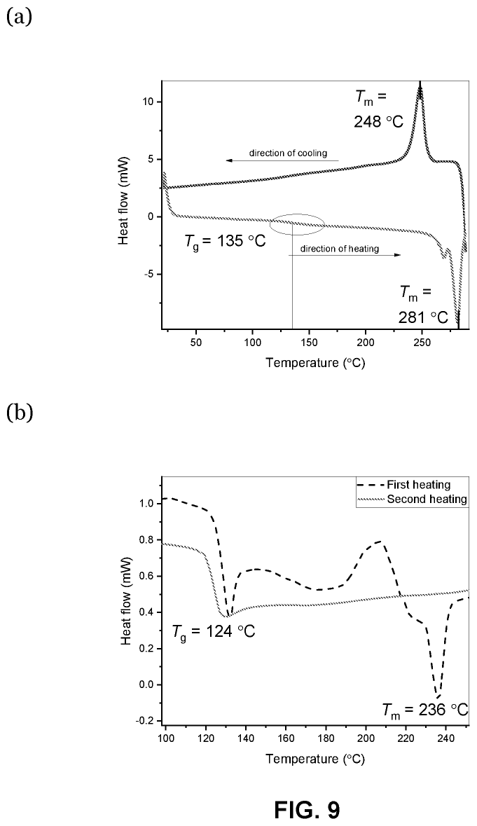

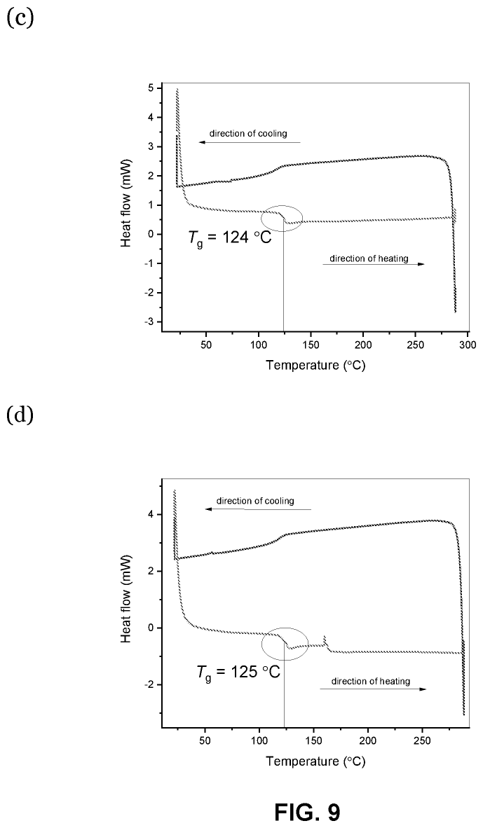

DSC revealed significant differences between the homopolymers and copolymer (FIG. 8, 9). Both sets of homopolymer were found to be semi-crystalline with a Tm of 271° C. and a minor Tg of 131° C. Poly(D-Ox/L-Ox) was fully amorphous with Tg of 128° C. The amorphousness of the copolymer substantiates the generally improved solubility in common organic solvents (THF, HCCl3, DMSO) as compared with the homopolymers. Incorporation of even a small amount of L-Ox was found to disrupt crystallinity. 90:10 poly (D-Ox/L-Ox) exhibited only a ill-defined Tₘ of 236° C. by DSC in the first heating cycle, which was not detected in the second scan, indicating slow crystallization kinetics. A Tg of 124° C. was detected in the second cycle. 70:30 poly (D-Ox/L-Ox) showed no crystallinity by DSC with a Tg detected at 125° C. in the second cycle.

### 2. Polymer Modification

### 2.1 Deprotection

Deprotection of the acetal group was carried out by acid hydrolysis. Reaction of a DCM: 80% aq. TFA solution of poly(D-Ox) at 0° C. yielded 85% deprotected polymer, poly (D-Ox2), after 8 h. The reaction was monitored by 1H NMR spectroscopy which revealed the isomerisation of anomeric position upon deprotection. Anomers were assigned based on the 1H {13C} HSQC spectra, which, β configurations occur at lower 1H {13C} shifts.

Deprotected samples were found to be insoluble in THF and HCCl₃, and soluble with heating in DMSO and DMF. In addition, samples became fully insoluble in THF, HCCl₃, DMSO, DMF and H₂O after 2 months on the benchtop, suggesting the formation of an extended hydrogen-bond network. Once deprotected, the OH groups may be amenable to further functionalisation.

### 2.1 Thermal Properties

85% deprotected polymer exhibiting a T_{d,onset} of around 145° C. (−170° C. with respect to poly (D-Ox)). The degradation event also became ill-defined with significant broadening of the mass loss transition. Additionally, no Tg or crystallinity was observed with 41% and 85% deprotected samples.

### 2.2 WAX Analysis

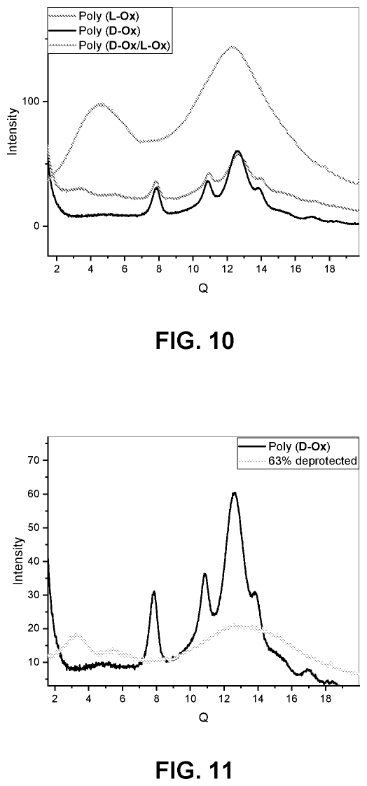

Wide-angle-X-Ray (WAX) characterisation of poly (D-Ox), poly (L-Ox), poly (D-Ox/L-Ox) and 63% deprotected poly (D-Ox) showed similar scattering profiles of poly (D-Ox) and poly (L-Ox) (FIG. 10). Broad peaks at Q values of between 7.5-15 may indicate crystallinity.

Poly (D-Ox/L-Ox) showed a significantly altered WAX profile as compared with the homopolymers (FIG. 10). A greater intensity of scattering was observed albeit with no crystalline peaks detected. This suggests the amorphous nature of the copolymer.

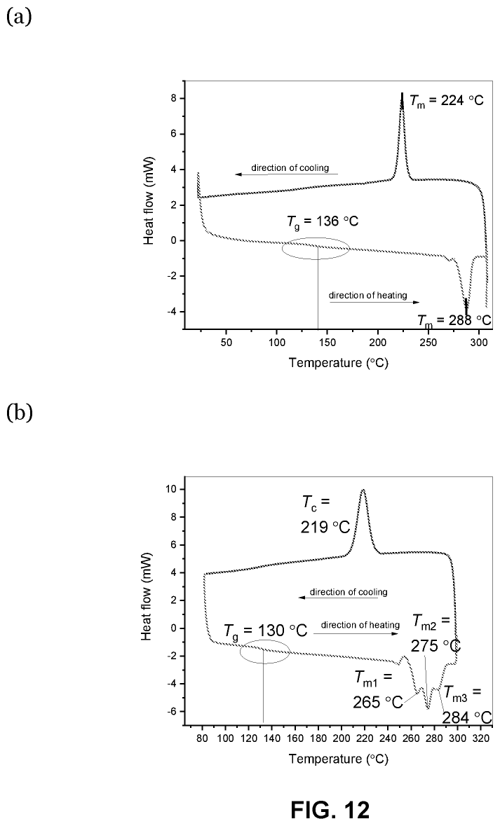

WAX analysis of 63% deprotected poly (D-Ox) showed loss of crystallinity at Q values between 7.5-15 (FIG. 11). Increased intensity of the broader peaks at low Q values (2-6) indicates the presence of larger domains potentially formed as a result of cross-linking in the samples. This suggests the presence of hydrogen-bond networks in the solid state.

### 3 Stereocomplexation

### 3.1 Synthesis

Stereocomplexes were prepared by dissolving samples of poly (L-Ox) (M_{n,SEC}=9400 g mol⁻¹, Ð_{M}=1.29) and poly (D-Ox) (M_{n,SEC}=9100 g mol⁻¹, Ð_{M}=1.25) in HCCl₃ and mixing the appropriate amounts to give 50:50 and 75:25 (poly (L-Ox): poly (D-Ox)) blends. Once mixed, the HCCl₃ solution was evaporated over an air stream. The blends were then left to dry in-vacuo at 80° C. overnight.

### 3.2 Thermal Characterisation

### 3.2.1 DSC of Stereocomplexes

DSC was used to assess stereocomplexation. Values discussed below were taken from the second heating cycle, unless stated otherwise. At a scan rate of 20° C. min⁻¹ the 50:50 blend exhibited an increased Tₘ, as compared with the homopolymers (288-289° C. and 271-282° C., respectively), diagnostic of a degree of stereocomplexation (FIG. 12). The 75:25 blend exhibited complex melting phenomena with Tₘ's detected at 249, 265, 275 and 284° C. The Tm at 284° C. was attributed to stereocomplexed polymer.

### 3.2.2 TGA of Stereocomplexes

Td,onset, Td5 and Td,max values were comparable to that of the homopolymers (see Table 2).

TABLE 2
TGA values of homopolymers and blends.

| Entry | Sample | Td, onset (° C.) | Td₅ (° C.) | Td, max (° C.) |
|---|---|---|---|---|
| 1 | Poly (D-Ox) | 315 | 348 | 402 |
| 2 | Poly (L-Ox) | 318 | 355 | 382 |
| 4 | 50:50^{[a]} | 320 | 353 | 372 |
| 5 | 75:25^{[a]} | 316 | 349 | 378 (388)^{[b]} |

TGA measured under Ar at heating rate of 10° C. min⁻¹. ^{[a]} Prepared by evaporation of HCCl₃ over an air stream. ^{[b]} Bracketed value taken from shoulder of derivative of mass loss.

### 3.3 WAX

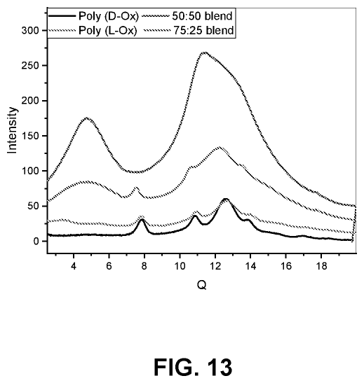

Comparison of the WAX profiles of the 50:50 and 75:25 blends with the homopolymers shows crystallinity is lost as the stoichiometries of poly (D-Ox) and poly (L-Ox) become equivalent (FIG. 13).

### 5. Hexose Derivatives

### 5.1 Synthesis of Galactal Derived Oxetane

Tri-O-acetyl-D-galactal (Carbosynth) may also being used as a synthetic precursor to form an oxetane monomer, for subsequent anionic initiation ring opening polymerisation of the oxetane moiety of the oxetane derivative. The method may start with a Ferrier rearrangement of 3,4,6-tri-O-acetyl-D-galactal using BF₃-EtO₂ as the catalyst and triethylsilane as the nucleophile to form 4.2 which is then de-protected using sodium methoxide under Zemplén conditions to afford 4.3 (Scheme 5).

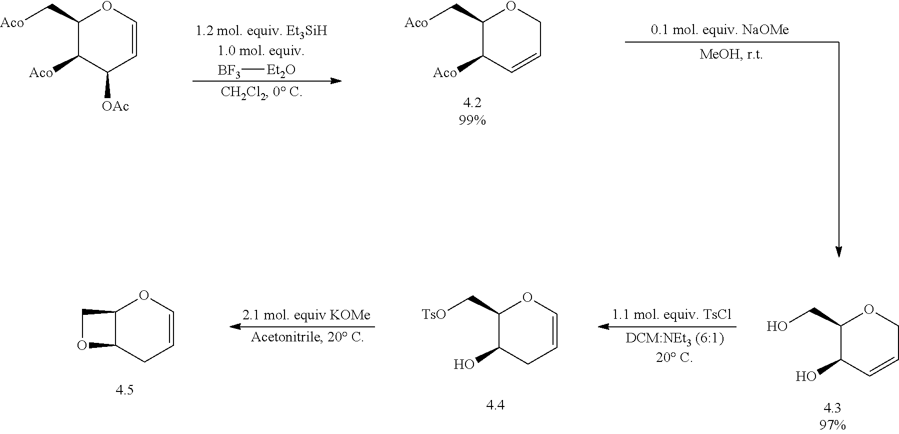

Scheme 5. Synthetic pathway for the preparation of bicyclic oxetane with unsaturation (4-5) from tri-O-acetyl-D-galactal.

Tosyl chloride was chosen to preferentially add to the primary alcohol group of the sugar molecule 4.3 in order to form the mono-substituted compound, 4.4.

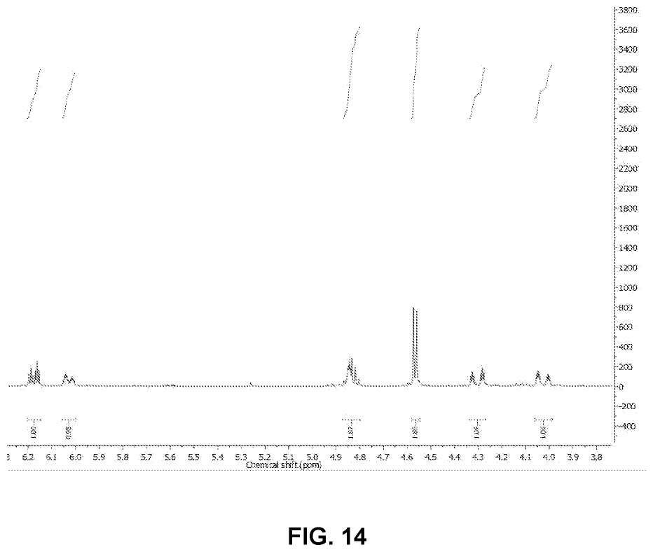

The cyclisation of the tosylated sugar molecules to give the oxetane proceeded using KOMe. The presence of the unsaturation provides a handle for post-polymerisation of a resulting polyether. FIG. 14 shows 1H NMR of galactal derived oxetane.

### 5.2 Experimental

### 5.21 Synthesis of ((2R,3R)-3-acetoxy-3,6-dihydro-2H-pyran-2-yl)methyl acetate

A solution of tri-O-acetyl-D-galactal (3.00 g, 11.0 mmol, 1.0 equiv.) in anhydrous DCM (25 mL) was cooled to 0° C., under argon, and treated with triethylsilane (2.11 mL, 13.2 mmol, 1.2 equiv.), followed by BF₃·OEt₂ (ca. 48%, BF₃) (1.38 mL, 11.0 mmol, 1.0 equiv.). The reaction was then stirred at 0° C. for 3 h. Once complete the reaction was quenched with NaHCO₃ (1 mol dm⁻³, 50 mL) and the organic phase was extracted using DCM (2×50 mL), washed with brine (50 mL) and water (2×50 mL), dried over MgSO₄, and the solvent was then evaporated in vacuo to yield a pale yellow oil, which was used directly in the next reaction without further purification (2.29 g, 96.2%).

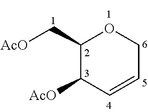 [SMILES: CC(=O)OC[C@H]1OCC=C[C@H]1OC(C)=O]

δ_{H} (400 MHz; chloroform-d): δ 6.05 (HC═CH, dddd, 1H, J_{HH}=10.2, 3.6, 1.7, 0.5 Hz), 5.95 (HC═CH, dddd, 1H, J_{HH}=10.0, 5.4, 2.2, 2.2 Hz), 5.05 (CHOAc, 1H, ddd, J_{HH}=4.8, 2.3, 2.3 Hz), 4.28 (OCH₂, 1H, ddd, J_{HH}=17.3, 3.6, 1.9 Hz), 4.21-4.10 (CH₂OAc, OCH₂, 3H, m), 3.83 (OCHCH₂, 1H, ddd, J_{HH}=7.5, 5.2, 2.4 Hz, 1H), 2.03 (CH₃COO, 3H, s), 2.02 (CH₃COO, 3H, s) ppm.

δc (101 MHz; chloroform-d): 170.71 (OCOCH₃), 170.47 (OCOCH₃), 132.36 (C═C), 122.16 (C═C), 73.77 (OCHCH₂), 65.73 (OCH₂), 64.31 (CHOAc), 63.30, (CH₂OAc) 20.90 (OCOCH₃), 20.81 (OCOCH₃) ppm.

### 5.22 Synthesis of (2R,3R)-2-(hydroxymethyl)-3,6-dihydro-2H-pyran-3-ol (4.3)

A solution of ((2R,3R)-3-acetoxy-3,6-dihydro-2H-pyran-2-yl)methyl acetate (2.28 g, 10.6 mmol, 1.0 eqiv.) in dry methanol (35 mL) was treated with a solution of NaOMe (0.098 g, 1.06 mmol, 0.1 equiv.) in dry methanol (2 mL) under argon and stirred at room temperature for 3 h. Once complete, ammonium chloride (0.114 g, 2.13 mmol, 0.2 equiv.) was added to the reaction and stirred for 15 mins. The reaction mixture was diluted with DCM (50 mL), the solids were removed by filtration, and the resultant filtrate was concentrated in vacuo to yield a pale yellow oil (1.39 g, 99.6%).

An alternative synthesis is as follows.

A solution of ((2R,3R)-3-acetoxy-3,6-dihydro-2H-pyran-2-yl)methyl acetate (3.77 g, 17.5 mmol, 1.0 equiv.) in anhydrous methanol (30 mL) was treated with a solution of NaOMe (0.095 g, 1.75 mmol, 0.1 equiv.) in anhydrous methanol (2 mL) under argon and stirred at room temperature for 3 h. Once complete, ammonium chloride (0.188 g, 3.52 mmol, 0.2 equiv.) was added to the reaction and stirred for 15 mins. The reaction mixture was concentrated in vacuo, and then diluted with chloroform (60 mL), the resultant precipitate was removed by filtration, and the filtrate was concentrated in vacuo to yield an off-white solid (2.25 g, 99%).

### 6. Functionalisation of Deprotected Polymer

The hydroxy groups of the deprotected polyether were demonstrated to be amenable to functionalisation: reaction of 25% deprotected poly (D-Ox) with chlorodiphenylphosphine in the presence of triethylamine and 4-dimethylaminepyridine yielded phosphorylated polymer, poly (D-Ox-P). SEC analysis indicated that the polymer remained intact following functionalisation. 1H, 1H-³¹P{¹H} HMBC and 1H DOSY NMR spectroscopy confirmed the incorporation of the P moiety within the polymer chains. ³¹P NMR spectroscopy also revealed that the phosphorous had oxidized during functionalisation likely as result of the presence of residual moisture in the 25% deprotected poly (D-Ox) sample. No T_{g} or Tₘ were detected for poly (D-Ox-P) by DSC.

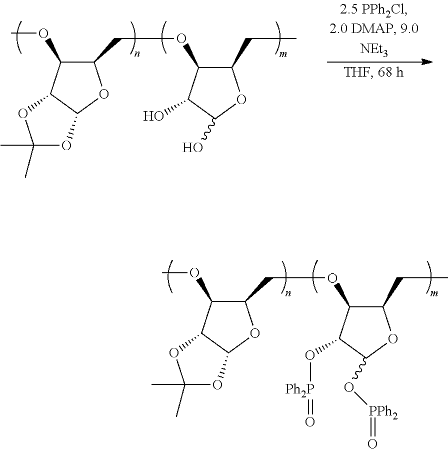

### 7. Synthesis of Branched Oxetanes and Derived Polyurethanes

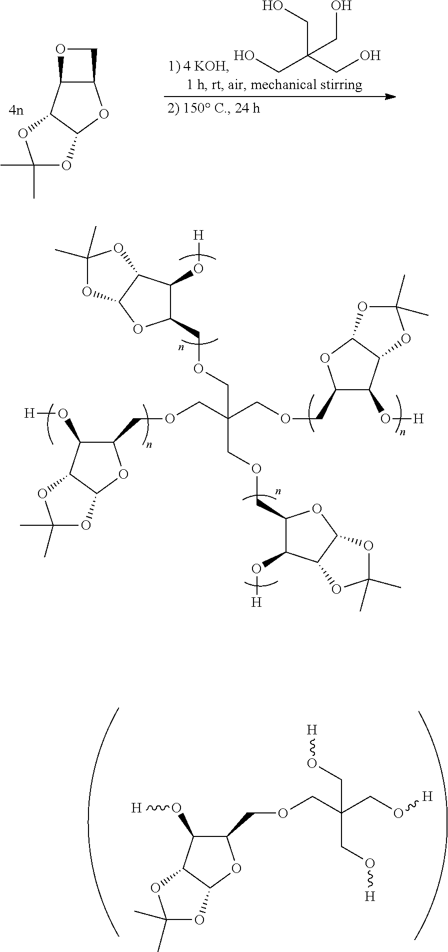

The synthesis of a branched polyol (poly(branched oxetane)) was carried using an anionic initiator in the presence of pentaerythritol. The reaction was performed in air using a mechanical stirrer on a 40 g scale of oxetane. Reaction progress was monitored by 1H NMR spectroscopy. Once the viscosity of the reaction mixture prevented efficient mixing, the reaction vessel was cooled to room temperature. The poly(branched oxetane) was characterised by 1H NMR spectroscopy, SEC (M_{n,SEC}=4200 g mol⁻¹, Ð_{M}=1.68), FTIR, TGA (T_{d,onset}=188; T_{d5}=222° C.; T_{d,max}=341° C. with 8% char remaining at 600° C.) and DSC (T_{g}=105° C., Tₘ not observed). Hydroxyl numbers were determined by titration and ³¹P NMR spectroscopy (2.43-2.47 mmols of OH per gram of poly(branched oxetane), corresponding to 136-137 mg KOH/g of polyol).

Polyurethanes were synthesised using three diisocyanates, namely, poly(methylene diisocyanate) (poly(MDI), 4,4′-methylene diisocyanate (MDI) and isophorone diisoycanate (IDI) (Table 3). Reactions were initially trialled in DMF (Table 3, entry 1), however due to the poor solubility of poly(branched oxetane), further reactions were performed in a DMSO:pyridine mix (3:1) which was found to solubilise the polyol upon heating (Table 3, entries 2-6). Addition of poly(MDI) resulted in the immediate formation of a brown precipitate, presumed to be a polyurethane (Table 3, entry 1). However, solution state analysis of the precipitate was not possible due to insolubility of the solid in common organic solvents (DMF, THF, DCM, MeOH). Reactions performed with 4,4′-methylenediisocyanate (MDI) and isophorone (IDI) proceeded with a significant increase in viscosity of the reaction solution (Table 3, entries 2-4). 1H NMR spectroscopic analysis indicated significant resonant broadening (FIG. 10). SEC analysis of the crude reaction mixture revealed a moderate increase in molar mass and a broadening of dispersity (˜2700-4000 g mol⁻¹, Ð_{M}=2.00-3.09) of the reaction product as compared with the poly(branched oxetane). Both 1H NMR spectroscopy and SEC analysis confirm polyurethane formation.

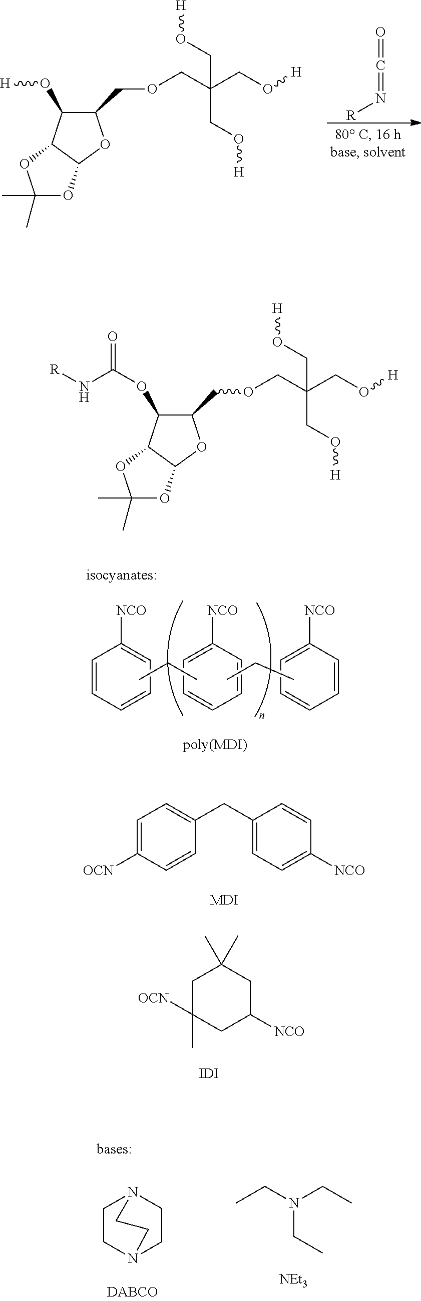

| | | | | M_{n, SEC} (g |
|---|---|---|---|---|
| Entry | Diisocyanate | Base | Solvent | mol⁻¹)^{[a]} |
| 1 | polyMDI | DABCO | DMSO:Pyridine (3:1) | —^{[b]} |
| 2 | IDI | NEt₃ | DMSO:Pyridine (3:1) | 2800 (2.00) |
| 3 | IDI | DABCO | DMSO:Pyridine (3:1) | 4200 (3.09) |
| 4 | MDI | DABCO | DMSO:Pyridine (3:1) | 2700 (2.04) |

Table 3. Synthesis of polyurethanes. Reactions performed with 0.250 g of poly(branched oxetane) at 80° C. with 0.5 equivalent of diisocyanate and 0.2 equivalent of base. Reactions quenched with MeOH after 16 h. ^{[a]} Determined by SEC relative to a polymethylmethacrylate standard using a DMF eluent; Ð_{M}=M_{w}/Mₙ as determined by SEC. ^{[ ]b]} residue insoluble in DMF and THF.

DSC collected at 20° C. min⁻¹ with a first cooling and second heating cycle under argon of poly(branched oxetane) gave T_{g}=105° C., Tₘ not observed.

TGA of poly(branched oxetane) determined that T_{d,onset}=188; T_{d5}=222° C.; T_{d,max}=341° C. with 8% char remaining at 600° C.

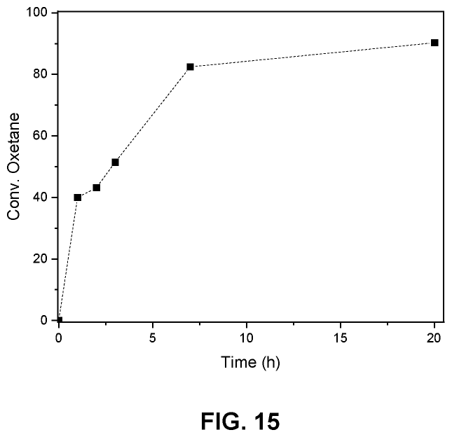

FIG. 15 shows a graph of time vs oxetane conversion (determined by 1H NMR (d⁶-DMSO) spectroscopy by relative integration of the anomeric protons in oxetane (6=6.27 ppm (d, J=3.7 Hz)) and poly(branched oxetane) (6=5.90-5.50 ppm (m)) for the KOH initiated ROP of oxetane at [oxetane]₀:[KOH]₀:[pentaerythritol]₀ loadings of 4:4:1 at 150° C.

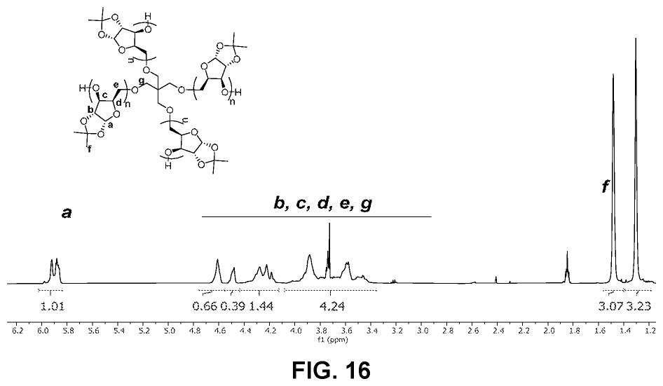

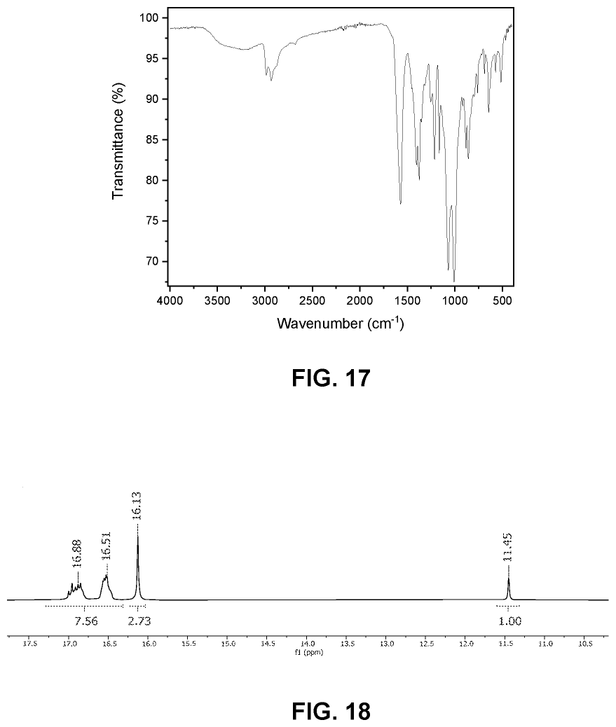

FIG. 16 shows the 1H NMR spectrum (CDCl₃) of poly(branched oxetane), and FIG. 17 shows the FTIR spectrum of poly(branched oxetane).

FIG. 18 shows the ³¹P{1H} NMR spectrum (CDCl₃) following the reaction of poly(branched oxetane) with 2-chloro-4,4,5,5-tetramethyl dioxaphospholane with bisphenol A used as an internal standard. The group of peaks to the left of the spectrum at 16 to 17 ppm relate to poly(branched oxetane) adduct and the peak on the right at 11.45 ppm to the BPA adduct. The spectrum was collected with a long delay (T1=10 seconds) to ensure the data was quantitative. The OH number was determined as 2.43 mmols of KOH (136 mg of KOH) per gram of polyol.

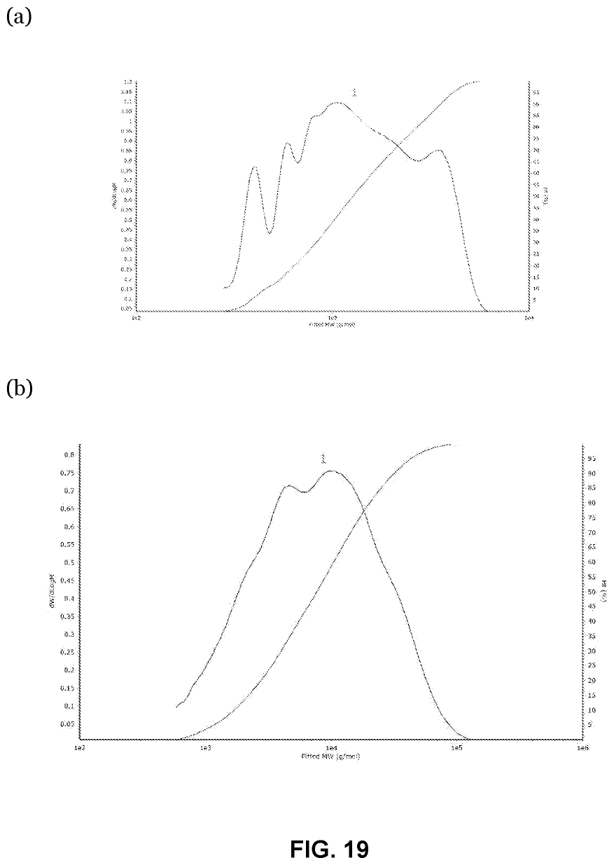

FIG. 19 shows (a) the SEC chromatogram of poly(branched oxetane) (M_{n,SEC}=4200 g mol-1, Ð_{M}=1.68) measured in DMF; and (b) SEC chromatogram of product of the reaction between poly(branched oxetane) and methylene diphenyl diisocyanate (M_{n,SEC}=4200 g mol⁻¹, Ð_{M}=3.09) measured in DMF.

### REFERENCES

[1] J. C. Worch, H. Prydderch, S. Jimaja, P. Bexis, M. L. Becker, A. P. Dove, Nature Reviews Chemistry 2019, 3, 514-535.
[2] Y. Ikada, K. Jamshidi, H. Tsuji, S. H. Hyon, Macromolecules 1987, 20, 904-906.
[3] J. M. Longo, A. M. DiCiccio, G. W. Coates, J. Am. Chem. Soc. 2014, 136, 15897-15900.
[4] a) F. Auriemma, C. De Rosa, M. R. Di Caprio, R. Di Girolamo, G. W. Coates, Macromolecules 2015, 48, 2534-2550; b) F. Auriemma, C. De Rosa, M. R. Di Caprio,
R. Di Girolamo, W. C. Ellis, G. W. Coates, Angew. Chem. 2015, 54, 1215-1218.
[5] I. Iribarren, C. Alemán, C. Regaño, A. Martínez de Ilarduya, J. J. Bou, S. Muñoz-Guerra, Macromolecules 1996, 29, 8413-8424.
[6] R. Marín, A. M. de Ilarduya, P. Romero, J. R. Sarasua, E. Meaurio, E. Zuza, S. Muñoz-Guerra, Macromolecules 2008, 41, 3734-3738.
[7] R. Marín, A. Alla, S. Muñoz-Guerra, Macromol. Rapid Commun. 2006, 27, 1955-1961.
[8] K. Nakano, S. Hashimoto, M. Nakamura, T. Kamada, K. Nozaki, 2011, Angew. Chem. 50, 4868-4871.
[9] J.-B. Zhu, E. M. Watson, J. Tang, E. Y. X. Chen, Science 2018, 360, 398.
[10] J.-B. Zhu, E. Y. X. Chen, Angew Chem. 2019, 58, 1178-1182.
[11] R. Klein, F. R. Wurm, Macromol. Rapid Commun. 2015, 36, 1147-1165.
[12] a) D. E. Fenton, J. M. Parker, P. V. Wright, Polymer 1973, 14, 589; b) N. Boaretto, L. Meabe, M. Martinez-Ibañez, M. Armand, H. Zhang, Journal of The Electrochemical Society 2020, 167, 070524.
[13] a) E. R. Ruckel, C. Schuerch, J. Am. Chem. Soc. 1966, 88, 2605-2606; b) E. R. Ruckel, C. Schuerch, The Journal of Organic Chemistry 1966, 31, 2233-2239; c) R. Xiao, M. W. Grinstaff, Prog. Polym. Sci. 2017, 74, 78-116.
[14] a) T. Y. Uryu, Koyama, Y. Matsuzaki, K., Macromolecules 1984, 185, 2099-2107; b) T. Y. Uryu, Koyama, Y. Matsuzaki, K., Journal of Polymer Science: Polymer Letters Edition 1979, 17, 673-678.
[15] a) P. Martin, B. Harmouch, D. Postel, G. Ronco, L. Spychala, P. Villa, 1994, 254, 325-331; b) N. G. Cooke, D. A. Jones, A. Whiting, Tetrahedron 1992, 48, 9553-9560.
[16] G. Visioli, A. M. Sanangelantoni, T. Vamerali, C. Dal Cortivo, M. Blandino, Molecules 2018, 23, 1461.
[17] M. Iwadate, T. Asakura, M. P. Williamson, Journal of Biomolecular NMR 1999, 13, 199-211.
[18] S. E. Felder, M. J. Redding, A. Noel, S. M. Grayson, K. L. Wooley, Macromolecules 2018, 51, 1787-1797.
[19] a) J. Slager, A. J. Domb, Adv Drug Deliv Rev 2003, 55, 549-583;
[20] a). L. Singfield, G. R. Brown, Macromolecules 1995, 28, 1290-1297. b). L. Singfield, J. M. Klass, G. R. Brown, Macromolecules 1995, 28, 8006-8015; b) Singfield, G. Brown, Journal of Materials Science 1999, 34, 1323-1331; c) Sakakihara, Y. Takahashi, H. Tadokoro, N. Oguni,
H. Tani, Macromolecules 1973, 6, 205-212.
[21] L. S. Morris, M. I. Childers, G. W. Coates, Angew. Chem. 2018, 57, 5731-5734.
[22] Z.-Q. Wan, J. M. Longo, L.-X. Liang, H.-Y. Chen, G.-J. Hou, S. Yang, W.-P. Zhang, G. W. Coates, X.-B. Lu, J. Am. Chem. Soc. 2019, 141, 14780-14787.
[23] Journal of Polymer Science: Polymer Letters Edition, 1979, Vol. 17(10), Uryu et. al., Cationic ring-opening polymerisation of 1,2-isopropylidene-D-xylofuranose, pages 673-678.
[24] Makromol. Chem., 1984, Vol. 185(10), Uryu et. al., pages 2099-2107.
[25] Makromol. Chem., 1979, Vol. 180, Uryu T. et. al., pages 1135-1144.
[26] Journal of Polymer Science, 1982, Vol. 20, Uryu T. et. al., pages 2181-2194.
[27] Journal of the Chemical Society, Perkin Transactions 1 1973, Vol. 16, Ferrier R. J. et. al., pages 1791-1793.

All publications mentioned in the above specification are herein incorporated by reference. Although illustrative embodiments of the present disclosure have been disclosed in detail herein, with reference to the accompanying drawings, it is understood that the present disclosure is not limited to the precise embodiment and that various changes and modifications can be effected therein by one skilled in the art without departing from the scope of the present disclosure as defined by the appended claims and their equivalents.

The disclosures of the published documents referred to herein are incorporated by reference in their entirety.

This application claims the priority of GB2012564.7 filed on 12 Aug. 2020, the entire contents of which are hereby incorporated by reference.

Although illustrative embodiments of the present disclosure have been disclosed in detail herein, with reference to the accompanying drawings, it is understood that the present disclosure is not limited to the precise embodiment and that various changes and modifications can be effected therein by one skilled in the art without departing from the scope of the present disclosure as defined by the appended claims and their equivalents.

1. A polymerisation process, the process comprising the steps of
a. providing an oxetane derivative of a monosaccharide,
b. providing an anionic initiator,
c. forming a reaction mixture comprising the oxetane derivative of the monosaccharide and the anionic initiator, and
d. initiating a ring opening polymerisation reaction of the oxetane moiety of the oxetane derivative of the monosaccharide in the reaction mixture, thereby producing a polyether.

2. The process of claim 1, wherein the oxetane derivative of a monosaccharide is an oxetane derivative of a pentose.

3. The process of claim 2, wherein the oxetane derivative of a pentose is an oxetane derivative of xylose.

4. The process of claim 2, wherein the pentose comprises an L-pentose.

5. The process of claim 2, wherein the pentose comprises an R-pentose.

6. The process of claim 2, wherein the pentose comprises a mixture of L-pentose and R-pentose.

7. The process of claim 1, wherein the monosaccharide comprises a hexose derivative.

8. The process of claim 1, wherein the reaction mixture comprises 100 mol % to 50 mol % oxetane derivative of the monosaccharide.

9-11. (canceled)

12. The process of claim 1, wherein the molar ratio of the oxetane derivative of the monosaccharide to the anionic initiator is in the range 10:1 to 400:1.

13. (canceled)

14. The process of claim 13, wherein the anionic initiator comprises a metal alkoxide and/or a metal amine.

15. The process of claim 14, wherein the reaction mixture further comprises a binding agent for metal cations.

16. (canceled)

17. The process of claim 1, wherein the oxetane derivative of the monosaccharide is an oxetane derivative of a 1,2-O-isopropylidene protected pentose.

18. The process of claim 2, wherein the oxetane derivative of a pentose is provided by the steps of:
reacting the pentose in the presence of sulfuric acid and acetone to form an 1,2-O-isopropylidene protected pentose,
either iodination or tosylation of the primary hydroxyl of the pentose, and
cyclising the iodo- or tosyl-pentose by treatment with base to form the oxetane derivative.

19. The process of claim 1, further comprising:
e. providing an oxetane derivative of a second monosaccharide,
f. providing an anionic initiator,
g. forming a reaction mixture comprising the oxetane derivative of the second monosaccharide and the anionic initiator, and
h. initiating ring opening polymerisation reaction of the oxetane moiety of the oxetane derivative of the second monosaccharide in the reaction mixture, thereby producing a polyether.

20. The process of claim 19, wherein the second monosaccharide is a pentose.

21-23. (canceled)

24. A linear or branched polyether of formula: 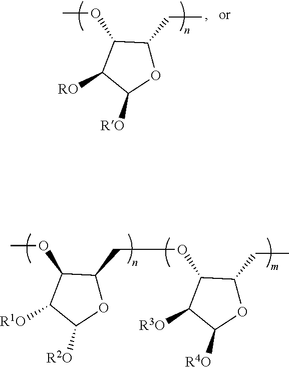
wherein n and m are independently 3 to 3500, and
R, R′, R¹, R², R³ and R⁴ are independently selected from H, PR⁵R⁶, P(O)R⁵R⁶, P(S)R⁵R⁶, BR⁵R⁶, Si(R⁵)₃, Si(OR⁵)₃, C₁₋₈ alkyl, C₃₋₇ alkenyl, C₂₋₇ alkynyl, C₅₋₂₀ aryl, C₃₋₁₀ cycloalkyl, C₃₋₁₀ cycloalkenyl, C₃₋₁₀ cycloalkynyl, C₃₋₂₀ heterocyclyl, and C₃₋₂₀ heteroaryl, or R and R′, or R¹ and R², or R³ and R⁴ together with the oxygens to which they are bonded form an isopropylidene acetal (ketal), or R and R′, or R¹ and R², or R³ and R⁴ are bonded to a divalent group, and
each R⁵ and R⁶ are independently selected from H, C₁₋₈ alkyl, C₅₋₂₀ aryl, C₃₋₁₀ cycloalkyl, C₃₋₂₀ heterocyclyl, and C₃₋₂₀ heteroaryl.

25. The polyether as claimed in claim 24, wherein R and R′, or R¹ and R², or R³ and R⁴ are bonded to a divalent group selected from —OP(R⁷)O— or —OB(R⁷)O— so that the polyether is of formula: 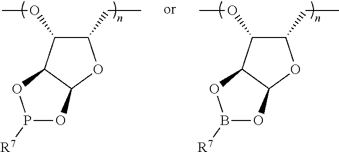
wherein each R⁷ is independently selected from H, C₁₋₈ alkyl, C₅₋₂₀ aryl, C₃₋₁₀ cycloalkyl, C₃₋₂₀ heterocyclyl, and C₃₋₂₀ heteroaryl, and each n is 3 to 3500.

26. A polyether stereocomplex comprising linear or branched polyethers of formula 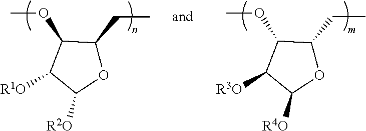
wherein n and m are independently 3 to 3500, and
R¹, R², R³ and R⁴ are independently selected from H, C₁₋₈ alkyl, C₃₋₇ alkenyl, C₂₋₇ alkynyl, C₅₋₂₀ aryl, C₃₋₁₀ cycloalkyl, C₃₋₁₀ cycloalkenyl, C₃₋₁₀ cycloalkynyl, C₃₋₂₀ heterocyclyl, C₃₋₂₀ heteroaryl, or R and R′, or R¹ and R², or R³ and R⁴ together with the oxygens to which they are bonded form an isopropylidene acetal (ketal), or R¹ and R², or R³ and R⁴ are bonded to a divalent group.

27. A polyurethane comprising a reaction product of an isocyanate and a polyether as claimed in claim 24.

28. (canceled)
